(19) United States
(12) Patent Application Publication
(10) Pub. No.: US 2010/0231644 A1
(43) Pub. Date: Sep. 16, 2010

(54) LIQUID EJECTION APPARATUS

(75) Inventor: Kenji OTOKITA, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/720,506

(22) Filed: Mar. 9, 2010

(30) Foreign Application Priority Data
Mar. 10, 2009 (JP) 2009-056026

(51) Int. Cl. B41J 25/304

(52) U.S. Cl. 347/37

(57) ABSTRACT

A liquid ejection apparatus includes a liquid ejection head having a nozzle row for ejecting liquid provided therein. A primary scanning unit performs a primary scanning by moving the liquid ejection head and an ejection target relative to each other in the direction intersecting a row direction of the nozzle row. A secondary scanning unit performs a secondary scanning by moving the ejection target and the liquid ejection head relative to each other so that positions of liquid to be ejected from the liquid ejection head on the ejection target are shifted at every pass of the primary scanning. The nozzle row includes large nozzles arranged at a center of the nozzle row for ejecting a relatively large quantity of liquid and small nozzles arranged at least one end side of the nozzle row for ejecting a relatively small quantity of liquid.

### BACKGROUND

1. Technical Field

The present invention relates to a liquid ejection apparatus.

2. Related Art

As a liquid ejection apparatus configured to eject liquid onto a target object, an ink jet printer configured to print characters or images on the printing medium by ejecting (discharging) ink thereon is well known. In a process of manufacturing displays such as liquid crystal displays, plasma displays, Organic EL (Electro Luminescence) displays, or Field Emission Display, a liquid ejection apparatus configured to eject coloring material or liquid-state various materials for forming electrode or the like to splash the same onto an image forming area, an electrode forming area or the like is used.

When the liquid ejection apparatus is used as a printer, a recording or printing operation is performed by ejecting ink while causing a printhead to travel with respect to the printing paper. As the printhead, a configuration having a nozzle row formed by arranging a plurality of nozzles for ejecting ink for a type of ink and recording or printing a plurality of lines by one stroke of scanning is employed. In the following description, the scanning operation in the direction intersecting the direction of the nozzle row, that is, a scanning performed by the printhead for recording or printing the plurality of lines simultaneously is referred to as a primary scanning, and a scanning in the direction to move from one primary scanning to another primary scanning is referred to as a secondary scanning. In the case of a general ink jet printer which causes the printhead to scan in a direction orthogonal to the direction of transport of the printing medium while transporting (feeding) the same, the direction of transport of the printing medium corresponds to a secondary scanning direction, and the direction orthogonal to the direction of transport corresponds to a primary scanning direction.

As a method of recording or printing with a printhead having the nozzle row, there are an interlace system and a band system. The interlace system is a system to repeat the primary scanning by shifting the nozzle row in the secondary scanning direction little by little, so that a higher resolution image is printed in comparison with the nozzle intervals (pitch) in the nozzle row. In contrast, the band system is a system to print of an area (band) by a width of the nozzle row in the each pass of primary scanning, so that a high speed printing is achieved. The printing of the band system is described, for example, in JP-A-2003-246054 and JP-A-2007-144788. In a technique described in JP-A-2003-246054, one band is filled by performing the printing intermittently in the primary scanning direction for the same band and repeating the same. In the following description, the primary scanning to the same band including such the repeated primary scanning is referred to as “one-pass primary scanning”.

In the band system printing, for example, when printing a highly colored image on a printing medium which is susceptible to smearing such as normal paper, there is a case where smearing appears remarkably at ends of the band which has no ink splashed at positions adjacent thereto and hence are in dry condition, and such smears are overlapped at boundary portions between two bands adjacent each other and hence black stripe is formed. Formation of such the black stripes is prevented by adjusting the amount of relative movement between the printhead and the printing medium in the secondary scanning. In other words, formation of such the black stripes is prevented by avoiding overlapping of the smears by securing a large distance between the respective bands of the primary scanning. However, when printing an image in a faint color in the state of being adjusted as described above, the extent of smear is little because the quantity of ink is small, so that white stripes are formed between the adjacent bands.

If an adjustment of the amount of movement in the secondary scanning on the band-to-band basis corresponding to the image to be printed is enabled, formation of the black stripes and the white stripes as described above is prevented. However, such control is complicated. In contrast, in JP-A-2007-144788, changing the number of nozzles to be used at ends according to the duty of the image in order to prevent the formation of stripes in band printing is described. However, in the technique described in JP-A-2007-144788, the strips are restrained by generating gradation at the boundaries between the bands.

### SUMMARY

An advantage of some aspects of the invention is to provide a liquid ejection apparatus which is able to alleviate formation of stripes at boundaries between bands when liquid ejection is performed in a band system.

According to an aspect of the invention is a liquid ejection apparatus comprising: a liquid ejection head having a nozzle row for ejecting liquid provided therein; a primary scanning unit configured to perform a primary scanning by moving the liquid ejection head and an ejection target relatively to each other in the direction intersecting a row direction of the nozzle row; and a secondary scanning unit configured to perform a secondary scanning by moving the ejection target and the liquid ejection head relatively to each other so that positions of liquid to be ejected from the liquid ejection head on the ejection target are shifted at every pass of the primary scanning, in which the nozzle row includes large nozzles arranged at a center of the nozzle row and configured to eject a relatively large quantity of liquid and small nozzles arranged at least one end side of the nozzle row and configured to eject a relatively small quantity of liquid, and the secondary scanning unit performs a secondary scanning in such a manner that a vacant area is formed between areas on the ejection target where liquid is ejected from the large nozzles in a primary scanning and a subsequent primary scanning, the ejection of liquid is performed on the vacant area by the small nozzles, and the liquid ejection positions of the small nozzles on the ejection target are shifted in the row direction of the nozzle rows from intervals of the liquid ejection positions of the large nozzles on the ejection target in the previous primary scanning or the subsequent primary scanning.

According to a second aspect of the invention, there is provided a liquid ejection apparatus including: a liquid ejection head having a nozzle row for ejecting liquid provided therein; a primary scanning unit configured to perform a primary scanning by moving the liquid ejection head and an ejection target relatively to each other in the direction intersecting a row direction of the nozzle row; a secondary scanning unit configured to perform a secondary scanning by moving the ejection target and the liquid ejection head relatively to each other so that positions of liquid ejected from the liquid ejection head on the ejection target are shifted at every pass of the primary scanning, in which the nozzle row includes large nozzles arranged at a center of the nozzle row and configured to eject a relatively large quantity of liquid and small nozzles arranged at both sides of the nozzle row and configured to eject a relatively small quantity of liquid, and the secondary scanning unit performs a secondary scanning in such a manner that a vacant area is formed between areas on the ejection target where liquid is ejected from the large nozzles in a primary scanning and a subsequent primary scanning, the ejection of liquid is performed on the vacant area by the small nozzles, and the liquid ejection positions of the small nozzles on the ejection target on the one side of the nozzle row in a primary scanning and the liquid ejection positions of the small nozzles on the ejection target on the other end side of the nozzle row in the previous and subsequent primary scannings are shifted from each other in the row direction of the nozzle row in the same vacant area.

Preferably, an area of the ejection target covered by ink ejected from each of the small nozzles is set to be half an area of the ejection target covered by the liquid ejected from each of the large nozzles.

Preferably, the plurality of small nozzles are formed in such a manner that the quantity of liquid to be ejected therefrom is decreased as it gets close from the side of the large nozzles toward the end of the nozzle row in the nozzle row.

Preferably, the large nozzles and the small nozzles are arranged to have regular center distances between the large nozzles, between the small nozzles, and between the large nozzle and the small nozzle.

According to the invention, when performing the liquid ejection in the band system, formation of strips in the band boundaries is alleviated by performing the liquid ejection by the small nozzles on the band boundary portions formed by the large nozzles.

### BRIEF DESCRIPTION OF THE DRAWINGS

The invention will be described with reference to the accompanying drawings, wherein like numbers reference like elements.

FIG. 1 is an explanatory drawing showing a configuration of a liquid ejection apparatus according to an embodiment of the invention and shows a schematic structure of a mechanism system and a block configuration of a control system for controlling the mechanism system.

FIG. 2 is an explanatory drawing showing smear at a boundary portion of a band.

FIG. 3 is an explanatory drawing showing a relation between a transport adjusting value and formation of white strips and black strips.

FIG. 4 is an explanatory drawing showing a nozzle arrangement of a liquid ejection head used in the liquid ejection apparatus shown in FIG. 1.

FIG. 5 is an explanatory drawing showing an operation of the liquid ejection head having the nozzle arrangement shown in FIG. 4 and showing positional relationship of the nozzles in two passes of primary scanning.

FIG. 6A is an explanatory drawing showing the operation of the liquid ejection head with the nozzle arrangement shown in FIG. 4 in the liquid ejection apparatus shown in FIG. 1 when there is a transport error of an ejection target in a pulse direction.

FIG. 6B is a drawing similar to FIG. 6A showing a case where there is a transport error of the ejection target in a minus direction.

FIG. 7 is an explanatory drawing showing a nozzle configuration of a liquid ejection head different from FIG. 4 used in the liquid ejection apparatus shown in FIG. 1.

FIG. 8 is an explanatory drawing showing an operation of the liquid ejection head having the nozzle configuration shown in FIG. 7 and showing a positional relationship in two passes of the primary scanning.

### DESCRIPTION OF EXEMPLARY EMBODIMENTS

Referring now to the drawings, an embodiment of the invention will be described.

### Entire Configuration

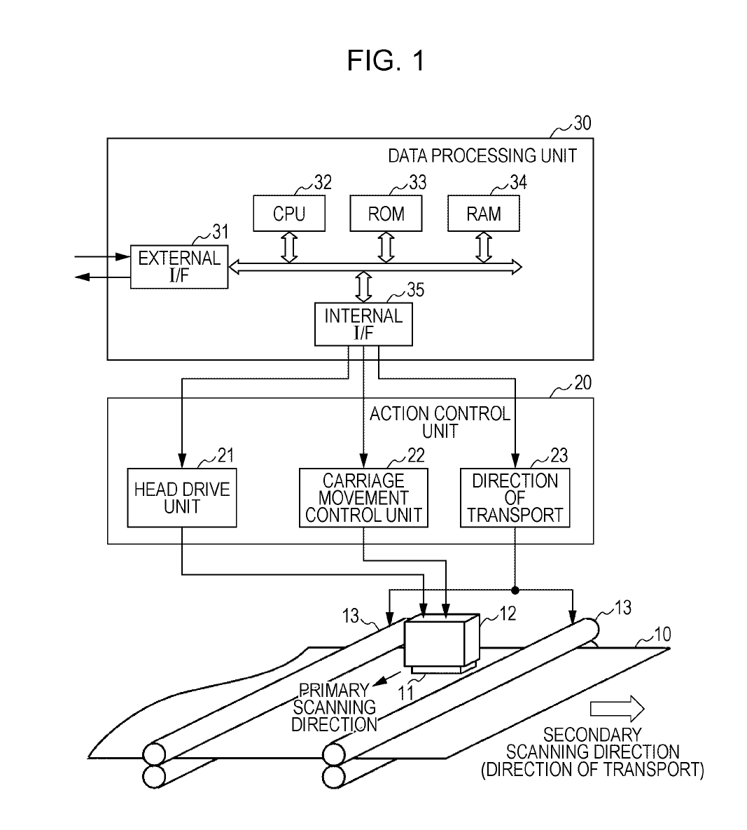

FIG. 1 is an explanatory drawing showing a configuration of a liquid ejection apparatus according to an embodiment of the invention, and shows a schematic structure of a mechanism system and a block configuration of a control system for controlling the mechanism system. In the description given here, an ink jet printer is taken as an example of the liquid ejection apparatus.

The liquid ejection apparatus shown in FIG. 1 is an apparatus configured to record and print an image by ejecting liquid-state ink onto a printing medium 10 as an ejection target, and includes a printhead 11 as a liquid ejection head, a carriage 12 which constitutes part of a primary scanning unit, and a transport apparatus 13 which constitutes part of a secondary scanning unit as a mechanism system. The printhead 11 is provided with a nozzle row for ejecting ink, as described later. The carriage 12 includes a mechanism for supplying ink to the printhead 11, and a mechanism for causing the printhead 11 to move with respect to the printing medium 10 (which is referred to as “primary scanning”), although not shown in the drawing. The transport apparatus 13, although only rollers are shown in FIG. 1, is configured to move the printing medium 10 with respect to the printhead 11 (which is referred to as “secondary scanning”).

The liquid ejection apparatus shown in FIG. 1 also includes an operation control unit 20 and a data processing unit 30 as a control system. The operation control unit 20 includes a head drive unit 21, a carriage movement control unit 22 which constitutes part of the primary scanning unit, and a transport control unit 23 which constitutes part of the secondary scanning unit. The head drive unit 21 controls an operation of the printhead 11. The carriage movement control unit 22 controls the movement of the carriage 12, and performs the primary scanning by moving the printhead 11 and the printing medium 10 relatively (in this embodiment, the printhead 11 is moved) in the direction intersecting the direction of row of the nozzle row of the printhead 11. The transport control unit 23 controls the relative movement of the positions of the printhead 11 and the printing medium 10 and performs the secondary scanning by moving the printing medium 10 and the printhead 11 relatively (in this embodiment, the printing medium 10 is moved) so that the positions of the ink ejected from the printhead 11 onto the printing medium 10 shift by every pass in the primary scanning direction. Here, for the sake of convenience of description, the head drive unit 21, the carriage movement control unit 22, and the transport control unit 23 are shown in the operation control unit 20 together. However, they are arranged integrally with the respective targets of control in the practical use. In other words, the head drive unit 21 is arranged integrally with the printhead 11, the carriage movement control unit 22 is arranged in the carriage 12, and the transport control unit 23 is arranged in the transport apparatus 13.

The data processing unit 30 includes an external interface 31, a central processing unit (CPU) 32, a ROM 33, a RAM 34, and an internal interface 35. The external interface 31 is connected to the external apparatus such as a host computer, a network, or the like, and receives print data or control data from the external apparatus and notifies the various data to the external apparatus. The central processing unit 32 performs processing of various data for processing the print data and controlling respective units in the liquid ejection apparatus. The ROM 33 stores a program used by the central processing unit 32 for processing and various fixed data required for the processing. The RAM 34 temporarily stores data transmitted and received via the external interface 31 and the internal interface 35, and temporarily stores the data to be processed by the central processing unit 32.

### Operation

An operation of the liquid ejection apparatus shown in FIG. 1 will be described. When print data is supplied from the external apparatus via the external interface 31, the print data is firstly stored in the RAM 34, and the central processing unit 32 converts the print data into dot pattern data corresponding to an ink dot pattern and temporarily stores the same in the RAM 34. When the dot pattern data to be printed by one pass of the primary scanning of the printhead 11 is obtained, the central processing unit 32 reads out the dot pattern data for the one pass of the primary scanning from the RAM 34 and outputs the same to the operation control unit 20 via the external interface 31.

The head drive unit 21 in the operation control unit 20 supplies drive signals to individual nozzles of the printhead 11 according to the supplied dot pattern data. As the printhead 11, those which allow an adjustment of the quantity of ink to be injected from the nozzle by the drive signal may be employed. For example, if it is configured to eject ink drops from the nozzles by applying a pressure to the ink by piezoelectric element, the adjustment of the quantity of ink ejected from the same nozzle is achieved by changing a drive pulse waveform of the piezoelectric element. Accordingly, any one of three types of dots, for example, small dots, medium dots, or large dots may be formed on the printing medium 10.

The carriage movement control unit 22 in the operation control unit 20 controls the movement of the carriage 12 having the printhead 11 attached thereto, and moves the printhead 11 with respect to the printing medium 10 in the primary direction. The transport control unit 23 in the operation control unit 20 controls the transport apparatus 13, and transport (feed) the printing medium 10 so that the relative position of the printhead 11 with respect to the printing medium 10 are moved in the secondary scanning direction.

When printing in the interlace system, the transport control unit 23 controls the amount of transport of the printing medium 10 by the transport apparatus 13 at intervals smaller than the nozzle interval of the printhead 11, and the spaces between the lines printed at one pass of primary scanning are printed by other passes of the primary scanning. In contrast, in the band system printing, the printing medium 10 is transported by an amount corresponding to the width of the nozzle area of the printhead 11 after the one-pass primary scanning.

### Formation of Strips at Band Boundaries

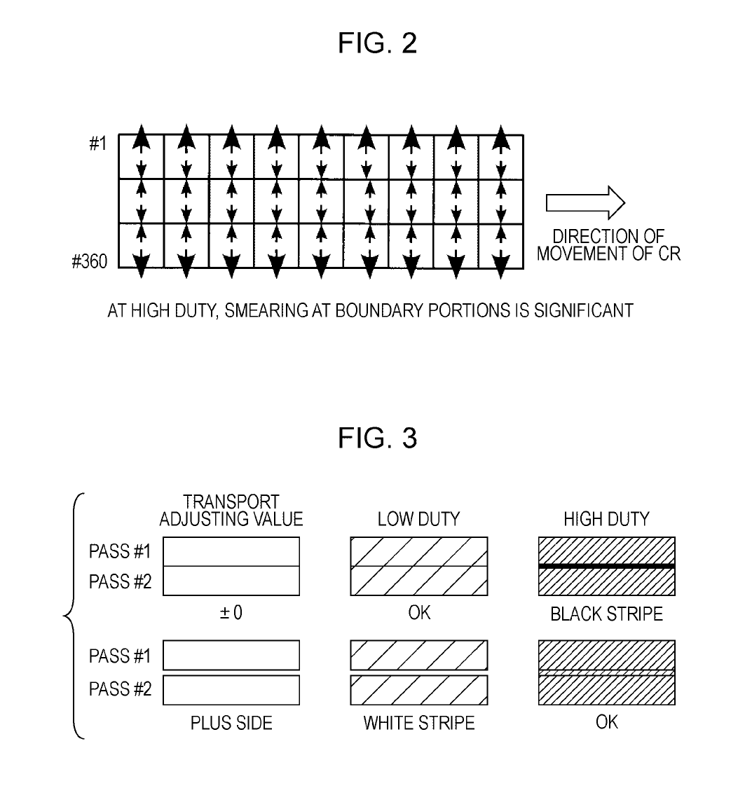

FIG. 2 is an explanatory drawing showing smear at a boundary portion of the bands. Here, assuming that the number of nozzles in the band is 360, nozzle numbers are indicated at the left end. As described above, if a high-duty printing is performed when the printing medium 10 is a paper which is susceptible to smearing such as a normal paper, the smearing of ink appears remarkably at boundary portions where no ink is splashed at positions adjacent thereto and hence are in dry condition. In FIG. 2, smearing at upper and lower portions is significant.

FIG. 3 is an explanatory drawing showing a relation between a transport adjusting value and formation of white strips and black strips. An adjustment of the amount of transport of the transport apparatus 13 in the band printing is achieved by the transport control unit 23 on the basis of instructions from the data processing unit 30. Now, it is assumed that a state in which the intervals of adjacent dots printed by the two passes of primary scanning are equal to the dot pitch to be printed in each pass of primary scanning is referred to as “the transport adjusting value is zero”. Also, it is assumed that a state in which the intervals of adjacent dots printed by the two passes of primary scanning are larger than the dot pitch to be printed in each pass of primary scanning is referred to as “the transport adjusting value is a plus value”. When the transport adjusting value is zero, in the case of low-duty printing which uses small quantity of ink, uniform dot intervals are achieved, so that a desirable printing quality is obtained. However, in the case of high-duty printing which uses large quantity of ink, smears are overlapped at boundary portions between bands, so that black strips may be formed. Such the black strips are prevented by adjusting the transport adjusting value to a plus value. However, when the transport adjusting value is adjusted to a plus value, white strips are formed when printing at low duties.

### Alleviation of Formation of Stripes

In order to alleviate formation of such the black strips or the white strips, the printhead 11 of the liquid ejection apparatus shown in FIG. 1, specific nozzles for the band-system printing are provided on both sides of the normal nozzles provided in the related art. This will be described below.

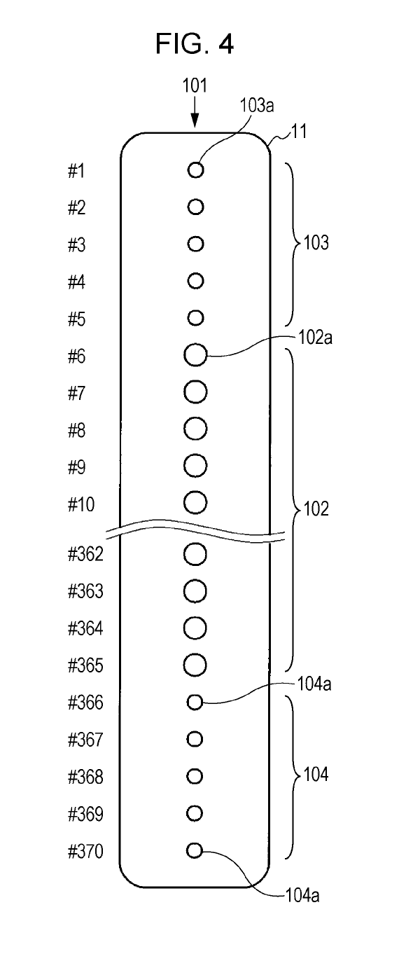

FIG. 4 is an explanatory drawing showing a nozzle arrangement of the printhead 11 used in the liquid ejection apparatus shown in FIG. 1. The printhead 11 is provided with a nozzle row 101 for ejecting ink, and the nozzle row 101 includes a large nozzle area 102 having large nozzles 102a arranged at the center of the nozzle row 101 and ejecting a relatively large quantity of liquid (ink), a small nozzle area 103 having a plurality of small nozzles 103a arranged on one end side of the nozzle row 101 and ejecting a relatively small quantity of liquid, and a small nozzle area 104 having a plurality of small nozzles 104a arranged on the other end side of the nozzle row 101 and ejecting a relatively small quantity of liquid. Liquid ejection ports of the respective large nozzles 102a have the same size, and liquid ejection ports of the respective small nozzles 103a and 104a have the same size. The area of the printing medium 10 covered by ink ejected from each of the small nozzles 103a and 104a is set to be half the area of the printing medium 10 covered by the ink ejected from each of the large nozzles 102a. By the setting as described above, the concentration per dot area formed by the large nozzle is substantially equalized to the concentration per dot area formed by the small nozzle. The term “half” does not mean exactly 0.5, but includes some allowance. For example, even when it is ⅓ or ⅔, an effect to some extent is obtained.

Here, an example for mono-color printing is shown as the printhead 11. However, if the apparatus is for color printing, the nozzle row 101 is provided for each type (color) of ink. However, if there is an ink type which is not involved to the band-system printing among the ink types, it is not necessary to provide small nozzles for the nozzle row for the corresponding ink type.

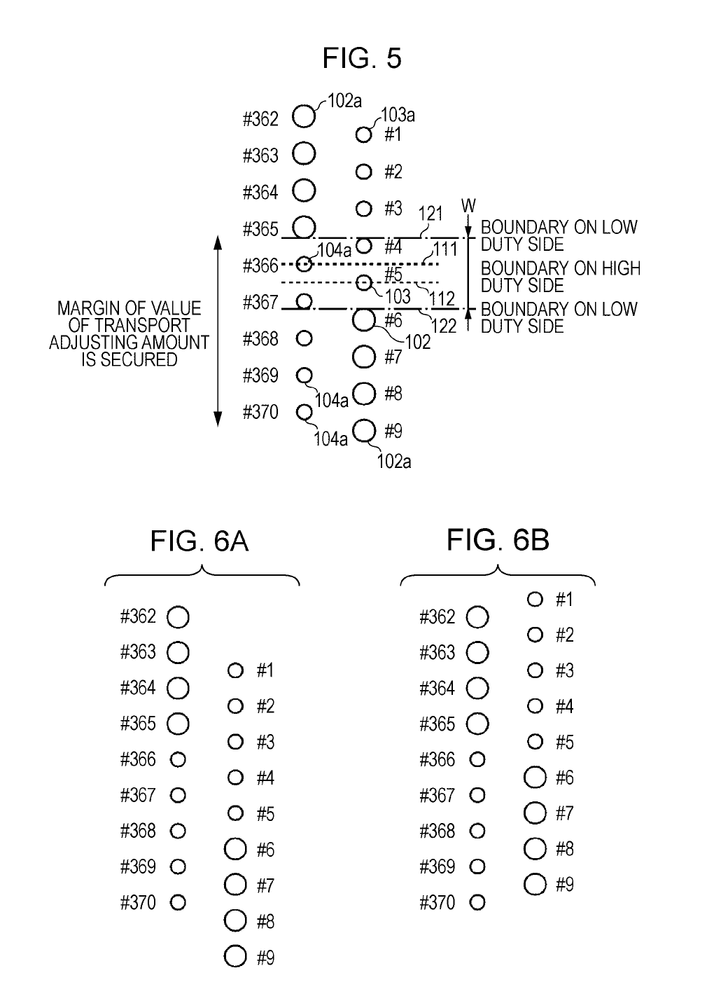

FIG. 5 is an explanatory drawing showing an operation of the printhead 11 having the nozzle arrangement shown in FIG. 4 and showing a positional relationship of the nozzles in two passes of primary scanning. A nozzle row on the left side in FIG. 5 corresponds to positions of the nozzles on the printing medium 10 for a first pass, and a nozzle row on the right side corresponds to positions of the nozzles on the printing medium 10 for a second pass.

When performing the printing by the printhead 11, the transport control unit 23 performs the secondary scanning in such a manner that a large nozzle-to-large nozzle area W is formed between areas on the printing medium 10 printed by the large nozzles 102a (areas where ink is ejected from the large nozzles 102a) in a primary scanning and a subsequent primary scanning as a vacant area, and the printing (ejection of liquid) on the large nozzle-to-large nozzle area W is performed by the small nozzles 103a and 104a without using the large nozzles 102a. Then, the transport control unit 23 performs the secondary scanning in such a manner that the printing positions (liquid ejection positions) of the small nozzles 103a and 104a on the printing medium 10 are shifted in the row direction of the nozzle rows from intervals of the ink ejection positions of the large nozzles 102a on the printing medium 10 in the previous primary scanning or the subsequent primary scanning. Alternatively, as shown in FIG. 4, when the plurality of small nozzles 103a and 104a are arranged on the both sides of the nozzle row 101, the transport control unit 23 performs the secondary scanning in such a manner that the printing positions of the small nozzles 103a or 104a on the printing medium 10 on the one side of the nozzle row 101 in one primary scanning and the liquid ejection positions of the small nozzles 104a or the small nozzles 103a on the printing medium 10 on the other end side of the nozzle row 101 in the previous and subsequent primary scannings are shifted from each other in the row direction of the nozzle row 101 in the same large nozzle-to-large nozzle area W. The number of small nozzles 103a and 104a is set to values so that a margin of the transport adjusting amount is secured. In the following description, nozzle numbers are used instead of reference numerals 102a, 103a, and 104a of the large nozzles and the small nozzles in order to avoid redundancy of description.

In the example shown in FIG. 5, positions of large nozzles #362 to #365 and small nozzles #366 to #370 in a first pass, and positions of small nozzles #1 to #5 and large nozzles #6 to #9 in a second pass are shown as a positional relationship among nozzles in the periphery of the band boundary in a two-pass primary scanning. The transport adjusting value is set so as to avoid overlapping of a boundary of dot smear 111 caused by the large nozzle #365 in the first pass with a boundary of dot smear 112 caused by the large nozzle #6 in the second pass at the time of high-duty printing. Then, the resolution is increased by the small nozzles #366 and #367 in the first pass and by the small nozzles #4 and #5 in the second pass to secure a concentration close to the concentration of the normal dot formed by the large nozzles even with the small dots. In general, the small dots are susceptible to smear and the probability that the smears of the small nozzles #366 and #5 overlap is low. In contrast, a boundary of dot smear 121 caused by the large nozzle #365 and a boundary of dot smear 122 caused by the large nozzle #6 are apart from each other by a relatively large extent at the time of low-duty printing. In this case as well, the concentration close to the concentration of the normal dot is secured by the small nozzles #366 and #367 in the first pass and the small nozzles #4 and #5 in the second pass. In this manner, smearing at the band boundary is alleviated, and hence formation of the white strips and the black stripes is alleviated in the printing from high duties to low duties by the single transport adjusting value.

FIGS. 6A and 6B are explanatory drawings showing the operation of the printhead 11 having the nozzle arrangement shown in FIG. 4 in the liquid ejection apparatus shown in FIG. 1 in a case where there is a transport error in the printing medium 10 as the ejection target. FIG. 6A shows a case where the transport error is a plus value, and FIG. 6B shows a case where the transport error is a minus value. The expression “the transfer error is a plus value” means that the printing medium 10 is transported excessively. The expression “the transport error is minus” means that feeding of the printing medium 10 is insufficient. When the transport error is plus, the dot interval between the large nozzles #365 and #6 is increased between passes. Therefore, in this case, a larger number of the small nozzles #366 to #368 and #3 to #5 than the number shown in FIG. 5 are used in the large nozzle-to-large nozzle area W. Also, when the transfer error is minus, the dot interval between the large nozzles #365 and #6 is reduced, and hence a smaller number of the small nozzles #368 and #5 than the number shown in FIG. 5 are used in the large nozzle-to-large nozzle area W. Since the transport error depends on individual liquid ejection apparatuses, and does not change so much after manufacture, the number of small nozzles to be used is set according to the respective liquid ejection apparatuses.

### Other Embodiments

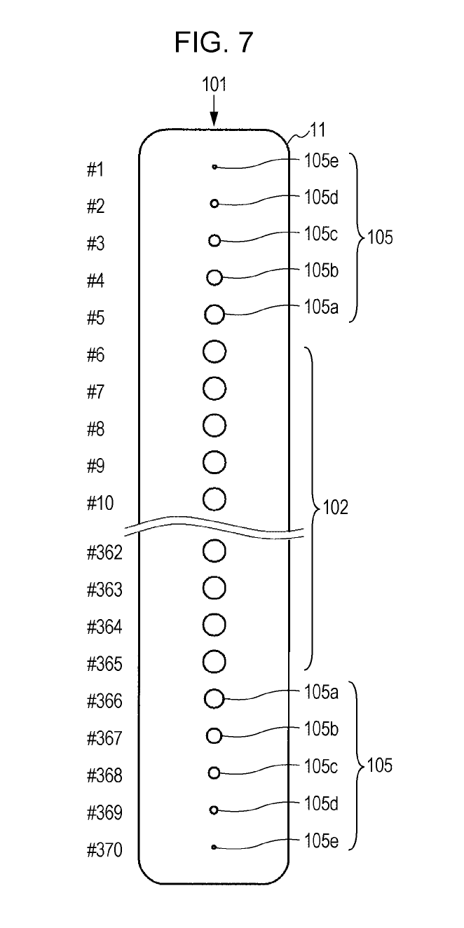

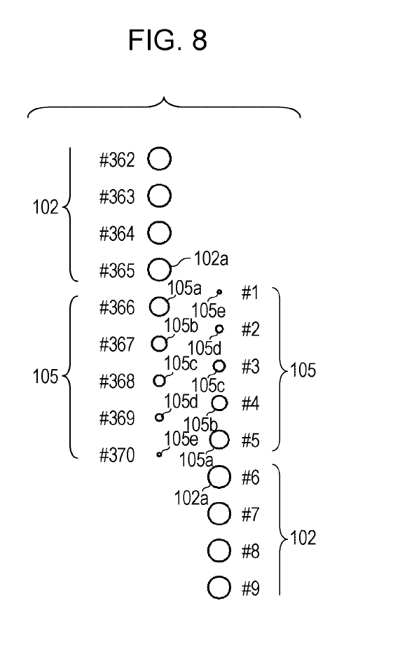

FIG. 7 is an explanatory drawing showing an example of nozzle configuration of the printhead 11 used in the liquid ejection apparatus shown in FIG. 1, which is different from FIG. 4. FIG. 8 shows a positional relationship of the nozzle in the two-pass primary scanning by the printhead 11 having the nozzle configuration shown in FIG. 7. According to the printhead 11 described in conjunction with FIG. 4 to FIG. 6, the small nozzles 103a and 104a have the same size. In contrast, the size of the small nozzles may be differentiated depending on the positions. In the example shown in FIG. 7 and FIG. 8, small nozzles 105a to 105e which constitute the small nozzle area 105 are formed in such a manner that the quantity of liquid (ink) to be ejected therefrom is decreased as it gets close from the side of the large nozzles 102a toward the end of the nozzle row 101 in the nozzle row 101.

In this case as well, the transport control unit 23 adjusts the relative positions of the ink head 11 with respect to the ejection target in such a manner that the ink ejection positions on the printing medium 10 by the small nozzles 105a to 105e (#1 to #5 in FIG. 7 and FIG. 8) in the small nozzle area 105 on one end side of the nozzle row 101 with respect to the previous ink ejection positions on the printing medium 10 by the small nozzles 105a to 105e (#366 to #370 in FIG. 7 and FIG. 8) in the small nozzle area 105 on the other end side of the nozzle row 101 are shifted in the direction of the nozzle row 101. Accordingly, dots of the relatively large sized small nozzle, for example, the small nozzle 105b and the relatively small sized small nozzles, for example, 105c and 105d are positioned adjacent to each other by two passes of the primary scanning, so that the concentration in the periphery of the normal dot is secured.

In the description given above, the small nozzle areas 103 and 104 or the small nozzle areas 105 and 105 are arranged on the both sides of the nozzle row 101. However, they may be arranged only at one end of the nozzle row 101. In this case, the concentration close to the concentration generated by the large nozzles 102a cannot be secured. However, by setting the transport adjusting value so as not to form the black strips at the time of high-duty printing, portions of the white strips formed at the time of low-duty printing when printing at the low duty can be formed with the dots, so that the white strips is alleviated to some extent.

The ink ejection position on the printing medium 10 by the small nozzles 103a, 104a, and 105a to 105e are set so as not to be overlapped at every primary scanning at the time of manufacture while taking the transport error into consideration. However, the displacement may occur due to age deterioration of the transport apparatus 13. In order to cope with such the age deterioration, it is desirable to enable calibration by test pattern printing even after the manufacture.

Although the liquid ejection apparatus according to the embodiment of the invention has been described, the invention may be implemented with various modification without departing the scope of the invention. For example, the primary scanning may be performed in the method described in JP-A-2003-246054. Also, the number of usage of the small nozzles 103a, 104a, and 105a to 105e may be changed according to the duty of the image.

A configuration in which the scanning of the printhead 11 with respect to the printing medium 10 is performed without moving the printing medium 10 is also applicable. In contrast, a configuration in which the printing medium 10 is moved without moving the printhead 11 is also applicable. The large nozzles 102a and the small nozzles 103a and 104a are arranged in actuality to have regular center distances between the large nozzles 102a, between the small nozzles 103a and the small nozzles 104a, and between the large nozzles 102a and the small nozzles 103a in terms of the structure for supplying ink or the structure for ejecting ink. The case of the small nozzles 105a to 105e is also the same. However, the nozzles do not necessarily have to be formed equidistantly in the invention. Also, the large nozzles 102a, at least some of the small nozzles 103a, 104a, and 105a to 105e may be arranged at positions shifted from a centerline of the nozzle row 101 instead of being arranged linearly on a line.

What is claimed is:

1. A liquid ejection apparatus comprising:
a liquid ejection head having a nozzle row for ejecting liquid provided therein;
a primary scanning unit configured to perform a primary scanning by moving the liquid ejection head and an ejection target relatively to each other in the direction intersecting a row direction of the nozzle row; and
a secondary scanning unit configured to perform a secondary scanning by moving the ejection target and the liquid ejection head relatively to each other so that positions of liquid to be ejected from the liquid ejection head on the ejection target are shifted at every pass of the primary scanning,
wherein the nozzle row includes large nozzles arranged at a center of the nozzle row and configured to eject a relatively large quantity of liquid and small nozzles arranged at least one end side of the nozzle row and configured to eject a relatively small quantity of liquid, and
the secondary scanning unit performs a secondary scanning in such a manner that a vacant area is formed between areas on the ejection target where liquid is ejected from the large nozzles in a primary scanning and a subsequent primary scanning, the ejection of liquid is performed on the vacant area by the small nozzles, and the liquid ejection positions of the small nozzles on the ejection target are shifted in the row direction of the nozzle rows from intervals of the liquid ejection positions of the large nozzles on the ejection target in the previous primary scanning or the subsequent primary scanning.

2. A liquid ejection apparatus comprising:
a liquid ejection head having a nozzle row for ejecting liquid provided therein;
a primary scanning unit configured to perform a primary scanning by moving the liquid ejection head and an ejection target relatively to each other in the direction intersecting a row direction of the nozzle row;
a secondary scanning unit configured to perform a secondary scanning by moving the ejection target and the liquid ejection head relatively to each other so that positions of liquid ejected from the liquid ejection head on the ejection target are shifted at every pass of the primary scanning,
wherein the nozzle row includes large nozzles arranged at a center of the nozzle row and configured to eject a relatively large quantity of liquid and small nozzles arranged at both sides of the nozzle row and configured to eject a relatively small quantity of liquid, and
the secondary scanning unit performs a secondary scanning in such a manner that a vacant area is formed between areas on the ejection target where liquid is ejected from the large nozzles in a primary scanning and a subsequent primary scanning, the ejection of liquid is performed on the vacant area by the small nozzles, and the liquid ejection positions of the small nozzles on the ejection target on the one side of the nozzle row in a primary scanning and the liquid ejection positions of the small nozzles on the ejection target on the other end side of the nozzle row in the previous and subsequent primary scannings are shifted from each other in the row direction of the nozzle row in the same vacant area.

3. The liquid ejection apparatus according to claim 2, wherein an area of the ejection target covered by ink ejected from each of the small nozzles is set to be half an area of the ejection target covered by the liquid ejected from each of the large nozzles.

4. The liquid ejection apparatus according to claim 2,
wherein the plurality of small nozzles are formed in such a manner that the quantity of liquid to be ejected therefrom is decreased as it gets close from the side of the large nozzles toward the end of the nozzle row in the nozzle row.

5. The liquid ejection apparatus according to claim 1,
wherein the large nozzles and the small nozzles are arranged to have regular center distances between the large nozzles, between the small nozzles, and between the large nozzle and the small nozzle.
